(19) United States
(12) Patent Application Publication
(10) Pub. No.: US 2021/0272440 A1
(43) Pub. Date: Sep. 2, 2021

(54) System to safeguard vehicle from flash flood and puddles

(71) Applicant: Mirza Faizan, Irving, TX (US)

(72) Inventors: Mirza Faizan, Irving, TX (US); Mirza Rizwan, Patna (IN); Aysha Shah, Holtsville, NY (US); Aiman Khan, Deer Park, NY (US); Simra Azim, Mount Sinai, NY (US); Hadiya Sameen, Mount Sinai, NY (US); Uzair Farooq, Huntington, NY (US); Aliza Khan, Mount Sinai, NY (US); Mahnoor Farooq, Huntington, NY (US); Saaim Imran, Miller Place, NY (US)

(21) Appl. No.: 17/185,066

(22) Filed: Feb. 25, 2021

Related U.S. Application Data
(60) Provisional application No. 62/982,697, filed on Feb. 27, 2020.

(51) Int. Cl. G08B 21/20; B60R 21/01

(52) U.S. Cl. CPC G08B 21/20; B60R 21/01; B60R 2021/0016; B60R 2021/01129; B60R 2021/01006

(57) ABSTRACT

An on-vehicle flash flood safety system is disclosed to install a water level sensor between front tires, underneath of vehicle which checks the water level on road. When the water level is found above a predetermined mark, an extendible-retractable shaft is extended which contains a water flow sensor and SONAR device to find the depth and speed of flash flood water. This data is sent to a Control, Display, and Alert Unit which calculates if it is dangerous to enter into such water. If found dangerous, the system gives an audio-visual alarm. System also collects location using GPS and sends location, water, and speed of water data to a computer server to be stored and distributed to other vehicles. By means of the aforesaid performance, on-vehicle flash flood alarm System informs the driver of the motor vehicle to not proceed if there is danger of the vehicle getting swept away.

### TECHNICAL FIELD

The present invention relates generally to a vehicle safety system, and more specifically the invention relates to the vehicle safety system for keeping such vehicles safe from flash floods and puddles on roads in an event that the flash flood or the puddles are above a predefined level.

### BACKGROUND OF THE INVENTION

Due to excessive exploitation of the earth, these days the sudden change in weather conditions has been noticed leading to heavy rain and floods causing unexpected damages to roads. It further leads to flash-flood which is a rapid flooding of low-lying areas like washes, rivers, dry lakes, and depressions. The National Weather Service (NWS) states that “People underestimate the force and power of water due to which many of the deaths occur in automobiles as they are swept downstream.” These events have aggravated in recent years due to instant change in weather conditions or heavy rain leading to flash floods occurring within minutes. ABC News affiliate WCPO.com reported that there are 200 deaths per year in the US alone due to flash floods after heavy rain and stalled system.

One of the common reasons for vehicles getting swept away in a flash flood is due to the inability of the driver to accurately access the force and destructive strength of flowing water. Furthermore, drivers are also not able to access the depth of water correctly due to many reasons like visibility, increasing slope on the road or even a part of the road is sometimes swept away in such furious floods. A system that enables a driver to accurately access the depth as well as the flow speed of the water considerably enhances the correct decision-making ability of the driver. Water moving at 10 miles an hour can exert the same pressures as wind gusts of 270 mph (434 kph), according to a 2005 article in USA Today. Water moving at 9 feet per second (2.7 meters per second), a common speed for flash floods, can move rocks weighing almost a hundred pounds. Flash floods carry debris that elevates their potential to damage structures and injure people.

As a result of the above, there has been some interest in providing vehicles with some form of security means to alarm the vehicle or alert the driver in an event of a flash flood or any puddles are above a danger level. An example of such is found in U.S. Pat. No. 6,650,244, published in Nov. 18, 2003. This publication describes an on-vehicle flood alarm system that automatically gives an alarm signal to the owner of the motor vehicle when a flood going to happen, informing the owner to take the necessary action in advance.

All of these conventional methods/systems or a computer program product, and some other method/system presently known in the art have had some flaws in design or mechanism and lacks precision. Most of the existing devices are too expensive and time consuming to be practical for most users. Some shortfalls of the existing method/system or a computer program product include manual interference. In light of this, there is a need for a method/system or a computer program product that overcomes these constraints.

In the light of these facts, it is of great advantage to the safety of the vehicle and its occupants that there is a system to accurately tell the depth of water as well as its flow speed. Furthermore, if a system makes its internal calculations and tells the driver if there is a danger for the vehicle to be swept away in flood, it will save hundreds of lives worldwide. There is a need for a vehicle security system that is designed to warn drivers of the impending dangers of the flood.

Further, there is also a need for a vehicle security system that provides an alarm to a driver so that the driver may make a proper decision while navigating flooded roads while some embodiments provide a system to give inputs to self-driving vehicles to make safety decisions without human intervention at all.

None of the above inventions and patents, taken either singly or in combination, is seen to describe the present invention as claimed. Thus, a vehicle Safety System from Flash-flood and Puddles that solves the aforementioned problems is desired.

Features and advantages of the invention will be set forth in the description that follows, and in part will be apparent from the description, or may be learned by practice of the invention. The advantages of the invention will be realized and attained by the structure particularly pointed out in the written description and claims thereof as well as the appended drawings.

It is to be understood that both the foregoing general description and the following detailed description are exemplary and explanatory and are intended to provide further explanation of the invention as claimed.

The present invention addresses the issues discussed above.

### SUMMARY OF THE INVENTION

The object of the present invention is to overcome the disadvantages of the prior arts and provide an onboard vehicle safety system for avoiding a vehicle from flash-flood and puddles, wherein the system include an extendable-retractable shaft, the shaft comprising an attachment means adapted to configure an extension and/or retraction of the shaft too and/or away from an underneath portion of the vehicle. A sensor housing positioned at a second end, the sensor housing comprising a plurality of sensors adapted to detect a flow and a height of water on the road, and A CDAU adapted to receive measurements from the plurality of sensors, wherein the CDAU includes a processor, a display and an alarm unit, wherein when the vehicle is moving on the road, the CDAU receives the measurements from the plurality of sensors and generates an alarm when the water level is above a predetermined danger level.

It is another object of the present invention to provide an on-vehicle security system for avoiding a vehicle from a flash flood that gives an audio and visual alarm to a driver of a vehicle 25 when flood conditions on the road may sweep away the vehicle, alarming the driver to not proceed on the flooded road and give accurate information about depth and speed of water flow to the driver via a Control, Display and Alarm Unit 24 installed in the vehicle 25.

It is another object of the present invention to provide an on-vehicle security system for avoiding a vehicle from a flash flood that gives calculated sensor inputs to the self-driven vehicle to automatically decide not to proceed on the flooded road if there is imminent danger of getting swept away.

It is another object of the present invention to provide an on-vehicle security system for avoiding a vehicle from flash flood to collect said information about flood and save it on a computer server, and from the computer, server distribute said information to one or more other on-vehicle security systems for avoiding a vehicle from the flash flood which is connected to the computer server, so that the driver may plan a safe route even before reaching the flooded road.

To achieve these and other objects of the present invention, the on-vehicle security system for avoiding a vehicle from flash flood comprises at least one water level Sensor, sound navigation and ranging (SONAR) device, a water flowmeter sensor, an alarm device, a light-emitting diode (LED) screen, a global system of mobile communications (GSM) system, a global positioning system (GPS) system, and a microprocessor. The water level sensor is provided in between the front tires underneath of the vehicle and spaced above the ground at a distance and adapted to detect accumulated water on the ground. The SONAR device and Water Flowmeter sensor are placed in a housing box. This housing box is attached to one end of a long extendable and retractable shaft (ERS). The other end of the extendable and retractable shaft (ERS) is attached at the front bottom of the vehicle.

When the driver notices flash floodwater on the road, the driver extends the ERS with sensors to fully extend and touch the water and read its flow speed and depth. The ERS enables the driver to read water speed and depth from few feet ahead of the vehicle, without even having a vehicle going in deep water. The data is then sent to Control, Display, and Alarm Unit (CDAU) for processing and finding out whether it is safe to enter the vehicle in the flash flood water. The CDAU also displays an underwater surface gradient and depth of water as captured by SONAR. Thus, enabling the driver to make an accurate decision along with visual and audio alarm, in case of danger. According to another embodiment of the invention, the system sends the water depth and water flow speed data to an auto-pilot system of self-driven vehicles, so the self-driven vehicles take their own safety decision without any interference from humans.

The world is moving towards connected machines and systems, talking to each other to share data and provide real-time information to each other. This invention also shares flash flood data along with GPS coordinates or locations in real-time. This is done by connecting each system to a central computer server so that each system might send and receive the latest data. This way, the driver may know much in advance about flash flood conditions along the route, even before reaching the location.

According to one embodiment of this invention, two such ERS with sensor housing may be used. This embodiment could reduce the cost by reducing to just one shaft and sensor housing and may enhance the dependability of system and acquired data by using more than two such sensor housing and shaft if needed for a large vehicle. Many water level sensor technologies could be used as a means of detecting water level on the road. Likewise, any water flow meter technology could be used as a means to read the flow speed of flash flood water. The CDAU incorporates an LED Display screen, Audio alarm system, GPS mapping system, GSM system to communicate with the computer server to send and receive the latest data, and a microprocessor.

Other objects, advantages, and features of this invention will become more apparent from the following description.

The details of one or more implementations are set forth in the accompanying description below. Other aspects, features, and advantages of the subject matter disclosed herein will be apparent from the description and the claims.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

Features, elements, and aspects of the invention that are referenced by the same numerals in different figures represent the same, equivalent, or similar features, elements, or aspects in accordance with one or more embodiments.

The following figure depicts a certain illustrative embodiment of the invention. This depicted embodiment is to be understood as illustrative of the invention and not as limiting in any way.

Referring particularly to the drawing for illustration only and not limitation, there is illustrated:

FIG. 1 shows a top view of a vehicle according to an embodiment of the present invention, illustrating the installation of the long extendable and retractable shaft (ERS) within the vehicle.

FIG. 2 shows a side view of the vehicles according to one embodiment of the present invention.

FIG. 3 shows a schematic block diagram of the vehicle safety system according to one embodiment of the present invention, including water level sensor 23, SONAR water flowmeter 15, Extendable-Retractable Shaft (ERF) 11, Extendable-Retractable system 12 and Control, Display and Alarm Unit (CDAU) 24.

FIG. 4 shows an arrangement of an extendable-retractable system mounting box cum extendable-retractable Shaft 12 at one end, connected underneath of the vehicle 25.

FIG. 5 shows an arrangement of the SONAR 17, Water Flowmeter 16, and Pan and Tilt mechanism at one end of the extendable-retractable shaft.

FIG. 6 shows the underneath of another end of the Extendable-Retractable Shaft 11 which has a pulley wheel and deployment mechanism to extend and retract the pulley wheel.

FIG. 7 shows Control, Display, and Alert Unit (CDAU) 24 fitted inside the vehicle.

FIG. 8 shows a water level sensor according to the prior art.

### DETAILED DESCRIPTION OF DRAWINGS

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment,” “an embodiment,” “at least one embodiment,” “one example,” “an example,” “for example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

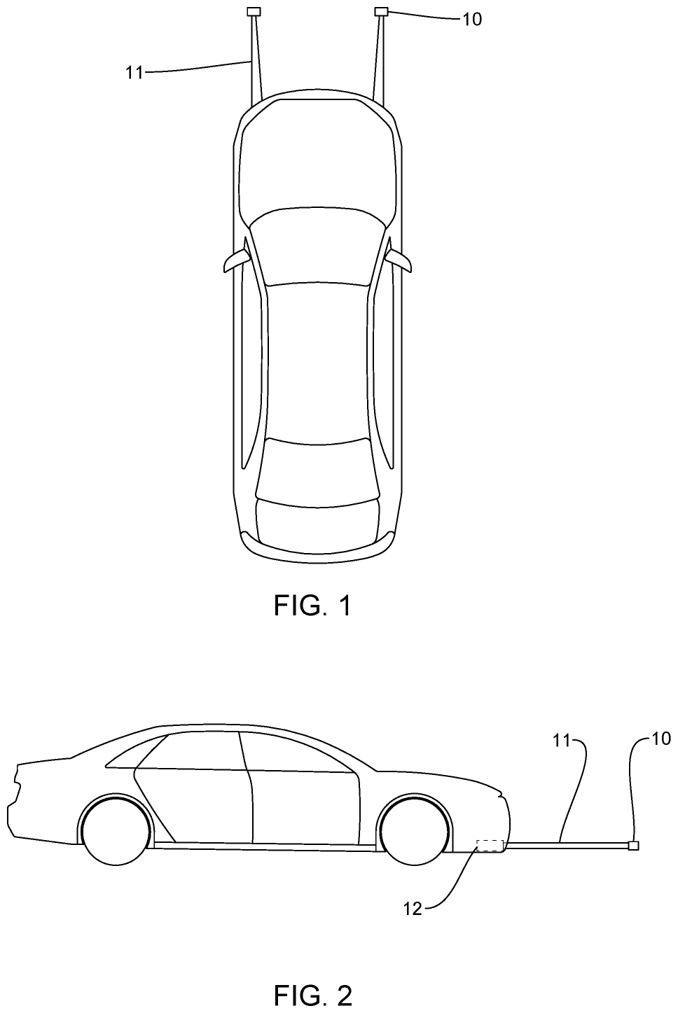

FIG. 1 shows the top view of a vehicle security system installed in vehicle 25 wherein an Extendable-Retractable Shaft (ERS) 11 is at an extended state. In this, one end of the ERS 11 may be attached underneath the vehicle and another end has a sensor housing 10. The sensor housing 10 may include a water flow meter sensor 16, and a SONAR device (17). In an embodiment, vehicle 25 may be either one of any gasoline-powered vehicle, a hybrid vehicle, an electric vehicle, a fuel cell vehicle, and/or any other mobility implement type of vehicle.

In an embodiment, the length of the Extendable-Retractable Shaft (ERS) 11 may be a user controller length. The user may control the length of the ERS based on the requirement. The ERS may be made up of a material that may not get affected by water.

FIG. 2 shows the side view of the vehicle security system installed in vehicle 25. The one end of the ERS 11 may end in an ERS cum Mounting Box 12, which may be connected underneath the vehicle on the front side as according to one embodiment of the present invention. The Mounting Box 12 is an integrated assembly for holding Extendable-Retractable Shaft (ERS) 11 in a closed state.

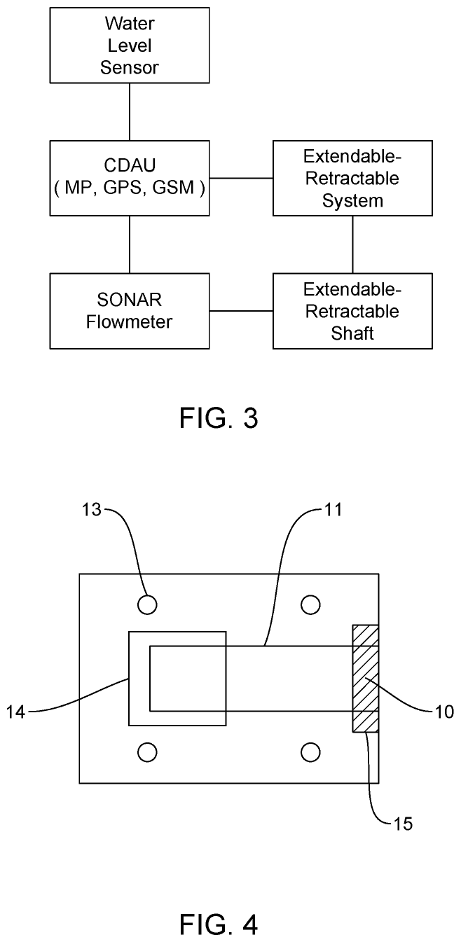

FIG. 3 shows a schematic block diagram of electronic components of vehicle 25 of FIG. 1. In the illustrated example, the electronic components include the water level sensor 23, the SONAR flowmeter 16, the water flowmeter 15, the Extendable-Retractable Shaft (ERF) 11, the Extendable-Retractable system 12, and the Control Display and Alarm Unit (CDAU) 24.

According to an embodiment of the invention, the control Display and Alarm Unit (CDAU) 24 may include a processor, a controller, and a memory. In some examples, the control Display and Alarm Unit (CDAU) 24 may be structured to include the water level sensor 23. Alternatively, in some examples, the water level sensor 23 may be incorporated into an electronic control unit (ECU) with its processor and memory.

Furthermore, the control Display and Alarm Unit (CDAU) 24 may include a wired or a wireless network interface that may enable communication with external networks 26. The control Display and Alarm Unit (CDAU) 24 may also include hardware (e.g., processors, memory, storage, antenna, etc.) and software to control the wired or wireless network interfaces. In some example, the control Display and Alarm Unit (CDAU) 24 may include one or more communication controllers for standards-based networks (e.g., Global System for Mobile Communications (GSM), Universal Mobile Telecommunications System (UMTS), Long Term Evolution (LTE), Code Division Multiple Access (CDMA), WiMAX (IEEE 802.16m); Near Field Communication (NFC); local area wireless network (including IEEE 802.11a/b/g/n/ac or others), and Wireless Gigabit (IEEE 802.11ad), etc.). In some examples, the control Display and Alarm Unit (CDAU) 24 includes a wired or wireless to communicate a couple with a mobile device (e.g., a smartphone, a smartwatch, a tablet, etc.).

In some examples, control Display and Alarm Unit (CDAU) 24 may include a global positioning (GPS) receiver that may provide one or more coordinates of the vehicle 25.

FIG. 4 shows the arrangement of an ERS mounting box cum extendable-retractable Shaft 12 at another end of the ERS 11. Shaft 12 may be connected underneath vehicle 25. The ERS mounting box cum extendable-retractable Shaft 12 may be connected underneath of vehicle by a nut-bolt system 13. The ERS mounting box cum extendable-retractable Shaft 12 may comprise an Extendable-Retractable System motor and electronics housing 14. Housing 14 may enable ERS 11 to extend and retract position whenever needed. When the ERS 11 is in the retracted state, the sensor housing 10 May rests inside a SONAR Water Flowmeter and Pulley Wheel housing slot 15.

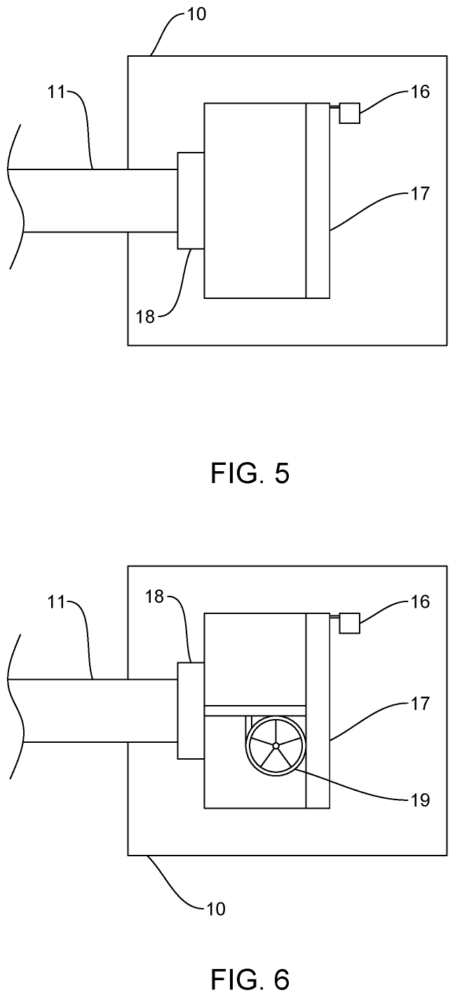

FIG. 5 shows an arrangement of the SONAR 17, the water Flowmeter 16, and Pan and Tilt mechanism 18 in the sensor housing 10 attached at the one end of extendable-retractable shaft 11. In an alternate embodiment, the extendable-retractable shaft 11 may be joined with the vehicle by a spring mechanism to handle the pressure of the water.

FIG. 6 shows the underneath of sensor housing 10, wherein the sensor housing 10 includes SONAR 17, the water Flowmeter 16, Pan and Tilt mechanism 18, and pulley wheel and deployment mechanism to extend and retract the ERS 11 via a pulley wheel system 19.

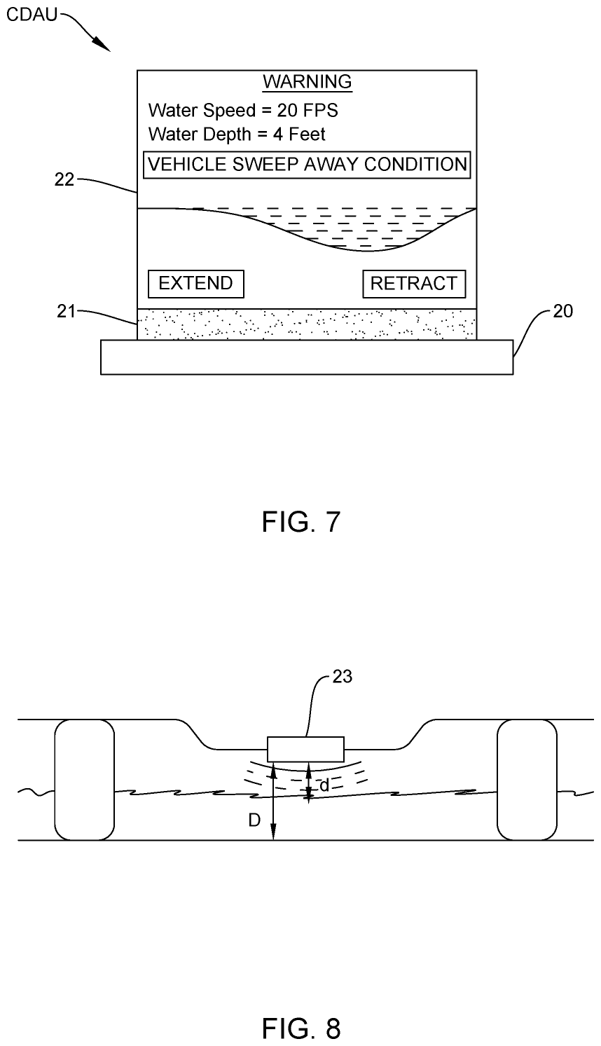

FIG. 7 is the view of the Control, Display, and Alert Unit (CDAU) fitted inside the vehicle where the driver can easily see and hear the alarm using CDAU mounting 20. The CDAU unit may include a speaker 21, a LED, and a screen 22.

As shown in FIG. 1 and FIG. 2, the present vehicle security system comprises a sensor housing 10 connected to one end of an extendable-retractable shaft 11. The sensor housing may include sensors like the SONAR device and water flow meter sensor. Furthermore, another end of the extendable-retractable shaft 11 may be connected to an Extendable-Retractable System cum Mounting Box 12. The Extendable-Retractable System cum Mounting Box may be connected underneath vehicle 25.

The embodiment of the present disclosure provides a kind of flash flood or any puddles detecting system that may be mounted on vehicle 25, as shown in FIG. 1, the flash flood or any puddles detecting System includes water level sensor, CDAU, Sonar flowmeter, Extendable retractable system, and Extendable retractable shaft. The sensor may be mounted on the predetermined position of the vehicle. The CDAU may include a speaker and a display screen to provide early warning of prompt information to the user device. In some examples, the control Display and Alarm Unit (CDAU) 24 may be connected to an external network 26. In such examples, vehicle 25 may communicate with the external network 26.

### A Detailed Description of the First Embodiment

In an implementation, a water level sensor 23 is for acquiring range data, and thereafter the range data may be sent to the processor. The range data may be a water level value. The value of the processor may be calibrated and set to 1 initially.

In this way, the processor from the water level sensor 23 obtains the water level value and then detects the water level value and the first preset threshold. When detecting water level value less than the first preset threshold, it is pre—that the control output CDAU may be used to indicate current first information, and when detecting that water level value is more than or equal to the first preset threshold then the water level sensor sends a signal to a Control, Display and Alert Unit (CDAU) screen 22 and the CDAU gives an audio-visual alarm to the driver to stop the vehicle immediately and measure the flow and depth of water ahead of the vehicle.

Thereafter, driver 26 may press a button on CDAU to extend the extendable-retractable shaft 11, so that the shaft extends along with the sensor housing 10 and reaches the flash flood water. Once the sensor housing touches the water, a water flow meter sensor 16 measures the speed of water flow while a SONAR device 17 detects the depth of water in front of the vehicle 25. The water flow meter sensor and the SONAR device records information of speed and depth of the water and send the information to the CDAU system, wherein the CDAU system receives the data and the processor predicts if the depth and speed of the water may cause the vehicle to get swept away.

If the processor determines that the depth and speed of water are indeed dangerous for the vehicle, it immediately gives a visual and audio warning to the driver. In some situations, the sensors might not be able to reach the water properly, for these situations the sensor housing 10 is mounted on a Pan and Tilt mechanism 18 to enable the sensors to reach and read water depth and speed properly.

According to an embodiment of the invention, the control Display and Alarm Unit (CDAU) 24 may include a global positioning (GPS) receiver that collects coordinates of the vehicle along with information of the water depth and water speed and send it using GSM module, to be stored in a computer server and distribute to CDAU of other vehicles, so that every vehicle on road knows the status of a flash flood on roads.

### A Detailed Description of the Alternative Embodiment

In an implementation, extension and retraction of the ERS 11 are done via a pulley wheel system 19, wherein the retractable pulley wheel system 19 may be located underneath the sensor housing 10. In case of widespread flooding, the driver may extend this pulley wheel so that the driver can even slowly drive and move forward as long as the CDAU system finds it safe to drive.

In yet another embodiment of the present invention, the water level sensor 23 may send the water level signal to the CDAU and the CDAU automatically extends the extendable-retractable shaft 11 and start operation without human intervention. This embodiment is most suitable for a self-driven vehicle of the future where there will be no driver to make a judgment about the safety of the car from a flash flood.

In an exemplary embodiment of the present invention, a plurality of users may be driving along a seaway, whereby there is already an alert of the flash flood by the authorities. Out of the plurality of users, a user operates the disclosed system and may be alarmed by the system of the possibility of getting stuck in the water. At this instance, the other users communicatively attached to the present system may get an alert of a possible drowning in the area where the user's car shas been stuck. Hence, this may safeguard others from entering into the dangerous area.

It is therefore submitted that the instant invention has been shown and described in what is considered to be the most practical and preferred embodiments. It is recognized, however, that departures may be made within the scope of the invention and that obvious modification will occur to a person skilled in the art. With respect to the above description then, it is to be realized that the optimum dimensional relationships for the parts of the invention, to include variations in size, materials, shape, form, function, and manner of operation, assembly, and use, are deemed readily apparent and obvious to one skilled in the art, and all equivalent relationships to those illustrated in the drawings and described in the specification are intended to be encompassed by the present invention.

It is noted that various connections are set forth between elements in the description and in the drawings (the contents of which are included in this disclosure by way of reference). It is noted that these connections in general and, unless specified otherwise, may be direct or indirect and that this specification is not intended to be limiting in this respect. In this respect, a coupling between entities may refer to either a direct or an indirect connection.

Various embodiments of the invention have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the Internet. The computer further comprises a microprocessor. The microprocessor is connected to a communication bus. The computer also includes a memory. The memory may be Random Access Memory (RAM) or Read-Only Memory (ROM). The computer system further comprises a storage device, which may be a hard-disk drive or a removable storage drive, such as, a floppydisk drive, opticaldisk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as the reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, “C,” “C++,” “Visual C++,” Java, and “Visual Basic.” Further, the software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various implementations of the systems and techniques described here can be realized in digital electronic circuitry, integrated circuitry, specially designed ASICs (application-specific integrated circuits), computer hardware, firmware, software, and/or combinations thereof. These various implementations can include implementation in one or more computer programs that are executable and/or interpretable on a programmable system including at least one programmable processor, which may be special or general-purpose, coupled to receive data and instructions from and to transmit data and instructions to, a storage system, at least one input device, and at least one output device.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus, and/or device (e.g., magnetic discs, optical disks, memory, Programmable Logic Devices (PLDs)) used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

A person having ordinary skills in the art will appreciate that the system, modules, and sub-modules have been illustrated and explained to serve as examples and should not be considered limiting in any manner. It will be further appreciated that the variants of the above-disclosed system elements, or modules and other features and functions, or alternatives thereof, may be combined to create other different systems or applications.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The claims can encompass embodiments for hardware, software, or a combination thereof.

Although a few implementations have been described in detail above, other modifications are possible. Moreover, other mechanisms for performing the systems and methods described in this document may be used. Also, the logic flows depicted in the figures may not require the particular order shown, or sequential order, to achieve desirable results. Other steps may be provided, or steps may be eliminated, from the described flows, and other components may be added to, or removed from, the described systems. Accordingly, other implementations are within the scope of the following claims.

### REFERENCE NUMERALS

10 Sensor housing
11 Extendable-Retractable Shaft (ERS)
12 Extendable-Retractable System cum Mounting Box
13 Attaching the nut-bolt system
14 Extendable-Retractable System motor and electronics housing
15 SONAR Water Flowmeter and Pulley Wheel housing slot
16 Water flowmeter sensor
17 SONAR device
18 Pan and Tilt mechanism
19 Retractable pulley wheel system
20 Control, Display and Alarm Unit mounting
21 Speaker for audio alarm
22 LED Screen
23 Water level sensor
24 Control, Display, and Alarm Unit
25 vehicle
26 Driver

What is claimed is:

1. An onboard vehicle safety system for avoiding a vehicle from flash-flood and puddles, the system comprising:
an extendable-retractable shaft, the shaft comprising:
an attachment means positioned at a first end underneath portion of the vehicle, wherein the attachment means is configured as an extension and/or retraction thereof from said shaft;
a sensor housing positioned at a second end, wherein the sensor housing comprises a plurality of sensors adapted to detect flow and a height of water on the road;
a CDAU adapted to receive measurements from the plurality of sensors,
wherein the CDAU comprises at least a processor, a display and an alarm unit;
wherein when the vehicle is moving on the road, the CDAU receives the measurements from the plurality of sensors and generates an alarm when the water level is above a predetermined danger level.

2. The onboard vehicle safety system for avoiding a vehicle from flash-flood and puddles as claimed in claim 1, wherein said extendable-retractable shaft having means to give pan and tilt motion at the joint between sensor housing and extendable-retractable shaft.

3. The onboard vehicle safety system for avoiding a vehicle from flash-flood and puddles as claimed in claim 1, wherein the plurality of sensors can be at least any one of a Sonar device, a Water flow sensor, and a Water level sensor.

4. The onboard vehicle safety system for avoiding a vehicle from flash-flood and puddles as claimed in claim 1, wherein said water level sensor sends water level data to said control, display and alarm unit which automatically extends shaft to measure flash flood water speed and depth without human intervention.

5. The onboard vehicle safety system for avoiding a vehicle from flash-flood and puddles as claimed in claim 1, wherein said control, display and alarm unit collects location from GPS and sends location, water depth, and speed data to a computer server, to be stored and distributed to other vehicle safety systems.
